(19) United States
(12) Patent Application Publication
(10) Pub. No.: US 2003/0033244 A1
(43) Pub. Date: Feb. 13, 2003

(54) Method and system for determining a person's interests and soliciting donation over a wide area network

(76) Inventors: Ephraim Feig, San Diego, CA (US); Harry E. Gruber, Rancho Santa Fe, CA (US)

Correspondence Address: Michael A. Rahman, Kintera, Inc., 9605 Scranton Road, Ste, 240, San Diego, CA, 92121, US

(21) Appl. No.: 09/927,656

(22) Filed: Aug. 10, 2001

(51) Int. Cl. G06F 17/60

(52) U.S. Cl. 705/39

(57) ABSTRACT

A web-based, interactive method for determining a person's interest in charitable, philanthropic, political or other social causes and for soliciting donations is disclosed. In one embodiment, the method utilizes a graphical user interface including a display. The method comprises the steps of asking a first question related to the causes, receiving a response to the first question, and determining, based on the response, if subsequent questions are necessary to identify one or more causes. If subsequent questions are not necessary, identifying, based on the response, at least one cause. The method further comprises asking one or more subsequent questions, if necessary, based on the prior response, identifying, based on the responses, at least one cause, and asking for a donation. The method further comprises receiving a donation on-line.

### BACKGROUND

1. Field of Invention

The present invention relates generally to on-line fundraising. More specifically, the present invention relates to a method and system for determining a person's interests in charitable, philanthropic, political or other social causes and soliciting donations over a wide area network, such as the Internet. The present invention intelligently determines an individual's interest in one or more charitable, political, or philanthropic causes, provides information about various nonprofit, charitable or political organizations involved in the causes, and seeks a donation.

2. Related Art

This application is related to a prior application titled “SYSTEM AND METHOD FOR INTERACTIVE FUNDRAISING OVER A WIDE AREA NETWORK”, filed Dec. 12, 2000, application Ser. No. 09/740,761. The subject matter of the prior application is incorporated herein by reference in its entirety.

3. Description of Prior Art

Charitable and other non-profit organizations often raise money through solicitations. These organizations establish contact with potential donors that may lead the potential donors to make a charitable contribution to the organizations. Common fundraising schemes include media events, mail campaigns, and telephone calls.

There are many nonprofit, charitable or political organizations engaged in various causes. These organizations are involved in different charitable activities, such as, for example, supporting medical research, environmental programs, religious and faith-based programs, educational institutions and political and social causes.

It is well known that individuals have different preferences with respect to charities. For example, an individual may be particularly interested in supporting medical research. Similarly, another individual may be interested in religious and faith-based programs. A third individual may be keen on supporting environmental campaigns to protect the wildlife.

When an organization, such as a charitable, nonprofit, educational or a medical foundation, contacts a person for a donation, it often lacks information about the person's preferences and interest with respect to the charitable causes. If a person who is only interested in supporting religious and faith-based programs is solicited by an environmental support group, the likelihood of receiving a donation is low. In contrast, if a religious organization contacts that same person, the likelihood of receiving a donation is higher. If a medical research foundation knows that a person is interested in supporting cancer research, then the likelihood of receiving a donation is high. Thus, it would be advantageous if an individual's personal interest in a charitable cause is known. The information about an individual's preference with respect to charities can be provided to relevant charities, which can efficiently target the individuals for donations.

Also, once an individual's personal interest with respect to charities can be determined, information about the charities can be provided to him directly by providing him a web page of the charities. This would increase the likelihood of that individual's making a charitable donation.

Current fundraising schemes do not provide an intelligent method or a system to obtain information about an individual's interest with respect to charities. These schemes also do not provide a method that directs individuals to web sites of charities of interest.

Accordingly, there is a need for a method and system that intelligently obtains information about individual preferences with respect to causes. There is a need for a system and method that directs individuals to their favorite charities' websites and solicits charitable donations.

### SUMMARY OF THE INVENTION

The invention is directed to a web-based, interactive method for determining a person's interest with respect to charitable, philanthropic, political or other social causes and for soliciting donations. In one embodiment, the method utilizes a graphical user interface including a display. The method comprises the steps of asking a first question related to the causes, receiving a response to the first question, and determining, based on the response, if subsequent questions are necessary to identify one or more causes. If subsequent questions are not necessary, identifying, based on the response, at least one cause. The method further comprises asking one or more subsequent questions, if necessary, based on the prior response, identifying, based on the responses, at least one cause, and asking for a donation.

The method further comprises receiving a donation on-line. The method further comprises providing information about the causes. In one embodiment, the method further comprises providing at least one link to a web page of the selected cause. The method further comprises retrieving the selected web page.

In one embodiment, the method comprises displaying information about other donors that have donated to the causes. The method further comprises displaying a virtual plaque honoring the donors. The method further comprises updating the virtual plaque to honor new donors.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like elements, in which:

FIG. 1 is a block diagram of one embodiment of the present invention in association with a wide area network;

FIG. 2 illustrates a scenario wherein a person enters a website of an organization involved in medical research;

FIG. 3 is a flow diagram illustrating the method steps in accordance with one embodiment of the invention; and

FIG. 4 illustrates the steps of soliciting and receiving a donation.

### DETAILED DESCRIPTION OF THE INVENTION

Turning first to the nomenclature of the specification, the detailed description which follows is represented largely in terms of system block diagrams, processes and symbolic representations by conventional computer components, including a processor associated with a general-purpose computer system, memory storage devices for the processor, and connected display devices. These operations include the manipulation of data bits by the processor and the maintenance of these bits within data structures residing in one or more of the memory storage devices. Such structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purpose of this discussion, a solicitor refers to a person or an organization soliciting a potential donor or an organization for a charitable donation. The solicitor may be a volunteer, an agent or an employee of a charitable, nonprofit or other organization. The solicitor may be a commercial fundraiser or an agent or employee thereof engaged for the purpose of assisting a charitable or other organization in its fundraising campaign. A donor refers to a person or an organization that makes a charitable donation. Also for the purpose of this discussion, a process or method is generally conceived to be a sequence of computer-executed steps leading to a desired result. These steps generally require manipulations of physical quantities. Usually, although not necessarily, these quantities take the form of electrical, magnetic, or optical signals capable of being stored, transferred, combined, compared or otherwise manipulated. It is conventional for those skilled in the art to refer to these signals as bits, values, elements, symbols, characters, terms, numbers, records, files or the like. It should be kept in mind, however, that these and some other terms should be associated with appropriate physical quantities for computer operations, and that these terms are merely conventional labels applied to physical quantities that exist within and during operation of the computer.

In addition, it should be understood that the systems and processes described herein are not related or limited to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hardwired logic or programs stored in non-volatile memory, such as read-only memory.

The present invention provides a solution to the above-mentioned problems associated with existing fundraising schemes. Briefly stated, the present invention is directed to a method and system for providing information about charities and soliciting donations over a wide area network, such as the Internet. The present invention intelligently determines an individual's interest in one or more charitable causes. The invention identifies appropriate nonprofit and charitable organizations based on the individual interest and solicits donations.

The present invention enhances traditional fundraising schemes, such as traditional donation solicitation, by intelligently determining donor preferences prior to solicitation. A potential donor is asked a series of questions concerning charitable activities and various charitable and nonprofit organizations. Responses to the questions are analyzed, and follow-up questions, if needed, are asked. Then, charities matching indicated preferences are identified. The potential donors are then provided further information about the identified charities. For example, potential donors are directed to web pages of the selected charities where they can learn more about the activities. Then potential donors are asked to make a donation to the charity.

The present invention can be conveniently utilized during entertainment or interactive events on various media, such the Internet. In one embodiment, the invention is utilized during a web-cast on the Internet or other wide area networks. A web-cast refers to a multimedia (video, audio, text, graphics, etc.) broadcast on the Internet. Participants can take part in an interactive session and can be enticed to answer one or more questions. More specifically, participants on the Internet can be asked one more questions to determine their interests in charitable, philanthropic, political and other social causes. The questions are designed to motivate and encourage participants to take an interest in the causes. The participants' answers are analyzed and their preferences with respect to these causes are identified. The participants are then asked to make a donation.

The present invention allows charitable and nonprofit organizations to efficiently and effectively reach out to an increased number of potential donors. Rather than targeting potential donors without adequate information about their interests and preferences, the present invention allows charitable and philanthropic organizations to target efficiently armed with valuable information regarding their interests and preferences on charitable activities and causes, thereby increasing the likelihood of receiving charitable donations. The invention motivates potential donors to make contributions to charitable and philanthropic organizations by providing information that is likely to encourage them to contribute. Furthermore, by eliminating blind targeting of potential donors, the invention decreases administrative costs associated unsuccessful solicitations.

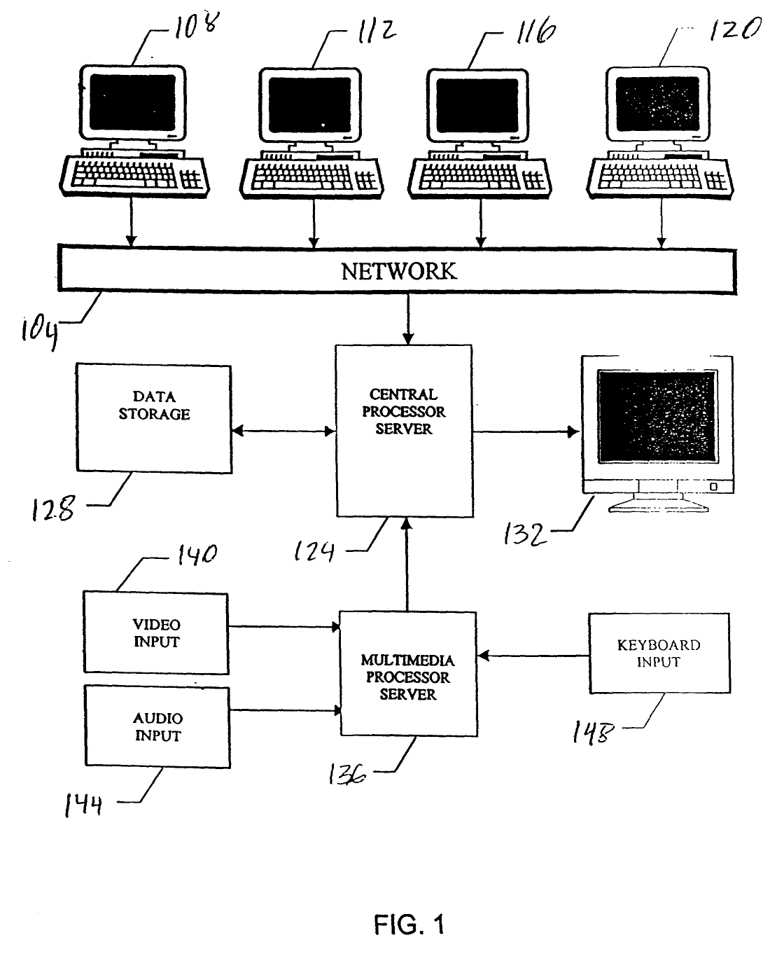

Referring now in more detail to the drawings, FIG. 1 is a block diagram of the present invention in association with a wide-area network. In FIG. 1, a wide-area network (e.g., the Internet) 104 is shown in conjunction with a number of representative user stations 108, 112, 116, and 120. It is well known in the art how to structure such wide-area network connections to provide two-way communication between various stations and locations connected to the network. In FIG. 1, a representative central processor server 124 is shown connected to the network 104 for two-way interactive communication between the central processor server 124 and the plurality of user stations. Also, as is well known in the art, many levels of communication can occur across network 104 as among individual stations and as between central processor servers and individual stations.

The present invention can be implemented over the wide area network 104, such as the Internet, using one or more web pages. The web pages allow a person to obtain information about charitable causes and organizations, answer questions, and make a donation. The web pages are accessed via the user stations 108-120.

In one aspect, the invention uses artificial intelligence to determine potential donors' preferences on various causes, including charitable, philanthropic, political and social causes. The invention uses knowledge and data obtained from prior donors preferences. The data and the knowledge is subsequently used to predict and determine the interests of potential donors, and to match appropriate causes with potential donors.

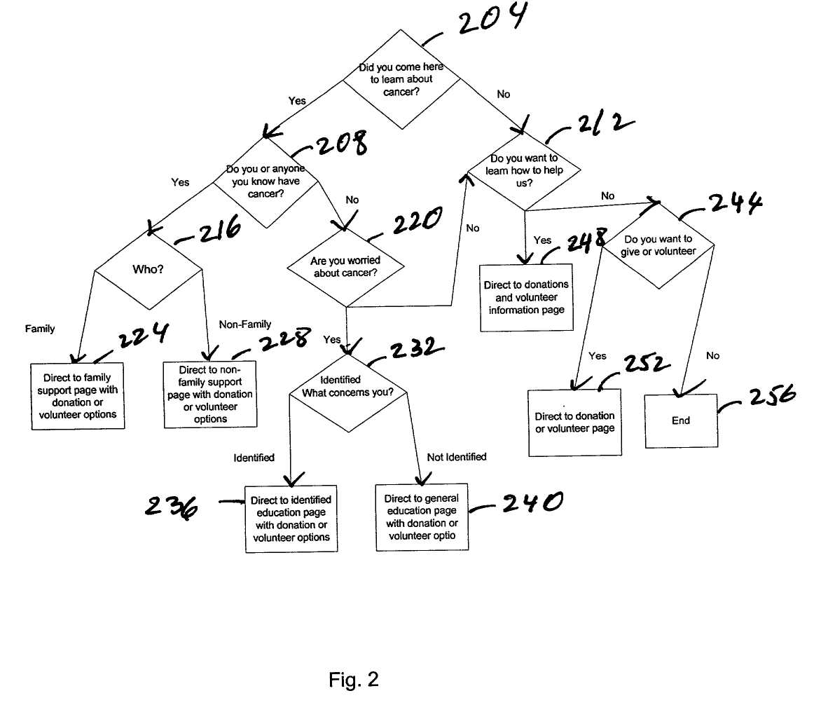

FIG. 2 is a flow diagram that illustrates a scenario wherein a person enters a website of an organization involved in medical research, namely cancer research. In step 204, he is asked if he would like to learn about cancer. If the answer is affirmative, the flow moves to step 208 where he is asked if he or anyone else he knows has cancer. If the answer is affirmative, then in step 216 he is asked further information about the cancer patient, such as for example, whether he is related to the patient. Depending on his answer, he is directed to a family support web page or a non-family support web page, in steps 224 and 228, respectively. The web pages provide additional information about cancer and also asks for a donation.

If the answer in step 208 is negative, the flow moves to step 220 where he is asked if he is worried about cancer. If the answer is affirmative, the flow moves to step 232 where he is asked to describe his concerns. The answer to step 232 is analyzed and it is determined whether a specific web page or a general web page is appropriate in view of the answer. Next, he is directed to an identified education page with donation/ volunteer option or a general education page with donation/volunteer option.

If the answers to steps 204 or 212 are negative, the flow moves to step 212. In step 212, he is asked whether he would like to learn how to help a charitable or nonprofit organization. If the answer is affirmative, the flow moves to step 248 where he is directed to a donation and volunteer information web page. If the answer is negative, in step 244 he is asked whether he would like to make a donation or volunteer. If the answer is affirmative, the flow moves to step 252 where he is directed to a donation or a volunteer web page. Otherwise, the flow ends in step 256. The foregoing flow diagram is provided as an example of determining a person's interest. Various other modifications and forms can be utilized to obtain information about a person's preferences.

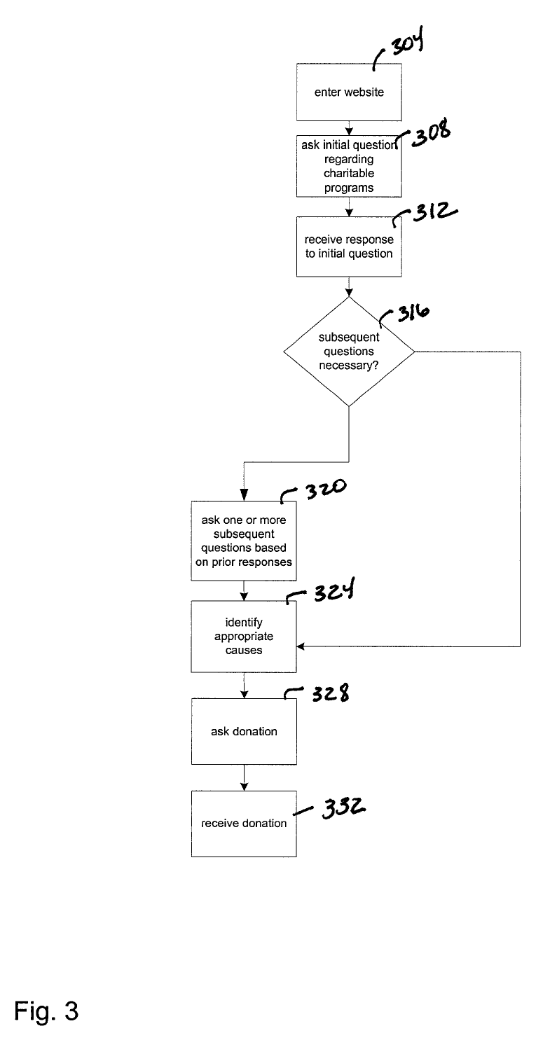

FIG. 3 is a flow diagram illustrating the method steps in accordance with one embodiment of the invention. In step 304, a potential donor enters a website. The website may host an interactive entertainment event or any other event. The event may be associated with a fundraising campaign. In step 308, the potential donor is asked a question related to charitable causes or programs. In step 312, a response is received. In step 316, the response is analyzed to determine if additional questions are necessary. If additional questions are necessary, then in step 320, one or more additional questions are asked. In step 324, the answers are analyzed to determine one or more charitable causes. In step 328, the potential donor is asked to make a charitable donation. In step 332, a charitable donation is received. Referring back to step 316, if additional questions are not needed, the flow moves to step 324.

In one embodiment, the potential donor is provided with selected web pages where the potential donor receives additional information about various charitable activities. The information can include a list of other donors who have made contribution to the cause. The web page can include one or more virtual plaques recognizing the donors. The virtual plaques are updated as additional donations are received.

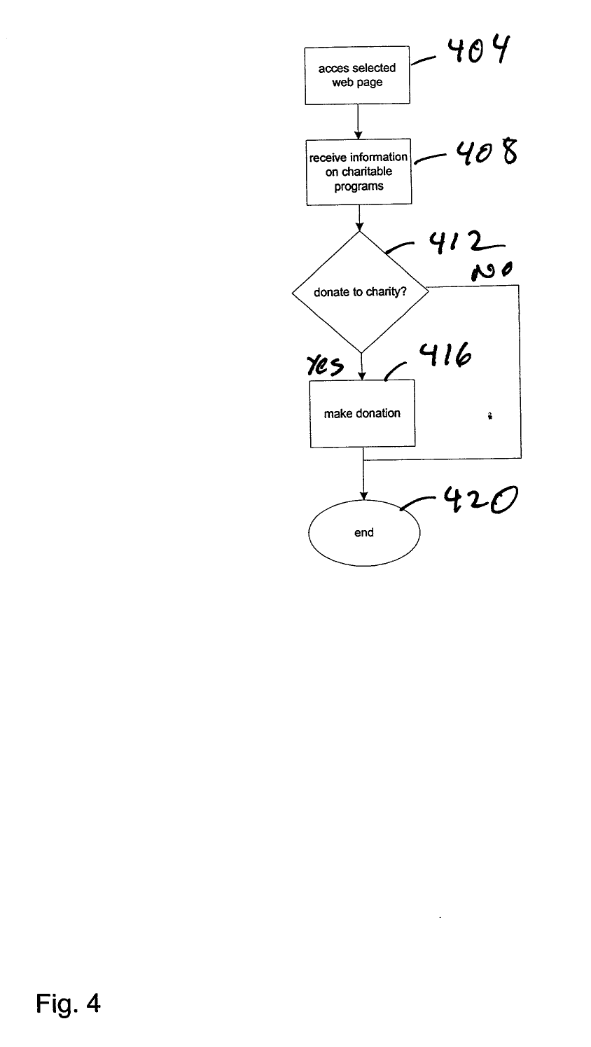

Referring now to FIG. 4, the potential donor accesses the selected web page in step 404. In step 408, additional information is provided to him. In step 412, the potential donor is asked if he would like to make a donation. If he wants to make a donation, the flow moves to step 416 where he can make an online donation or make a pledge. The flow ends in step 420.

In one embodiment, the program code for carrying out the steps in accordance with the present invention can be stored in a storage medium and made available for sale as a software program or a computer program product. For example, the program code can be stored in a compact disk (CD), a magnetic tape, or any other type of storage medium. A manufacturer can make the software program available for sale so that individuals and business entities may purchase or otherwise obtain the software program to set up an automated, on-line donation processing system.

Although the preferred embodiments have been described, it should be understood that various changes, substitutions, and alterations can be made herein without departing from the scope of the present invention. For example, although the present invention has been described and illustrated primarily in relation to Internet applications, it should be understood that the present invention is in no way limited to only the Internet and may be implemented on other networks also. Furthermore, it should be noted that the present invention can be implemented using virtually any computer system or other networking system and virtually any available programming language. Thus the implementation of the present invention is not limited to the computer network illustrated in this document. Other examples of changes, substitutions, and alterations are readily ascertainable by one skilled in the art and could be made without departing from the spirit and scope of the present invention as defined by the following claims.

What is claimed is:

1. A web-based, interactive method for determining a person's interest with respect to charitable, philanthropic or political causes and for soliciting donations, the method having a graphical user interface including a display, comprising:
asking a first question related to the causes;
receiving a response to the first question;
determining, based on the response, if subsequent questions are necessary to identify one or more causes;
if subsequent questions are not necessary, identifying, based on the response, at least one cause;
asking one or more subsequent questions, if necessary, based on the prior response;
identifying, based on the responses, at least one cause; and
asking for a donation.

2. The method according to claim 1, further comprising receiving a donation on-line.

3. The method according to claim 1, wherein the recited steps are conducted during an on-line event on the Internet.

4. The method according to claim 1, wherein the recited steps are conducted during a web-cast on the Internet.

5. The method according to claim 1, further comprising providing information about the charities.

6. The method according to claim 1, further comprising providing at least one link to a web page of the selected cause.

7. The method according to claim 6, further comprising retrieving the selected web page.

8. The method according to claim 1, wherein the questions influence an individual to make a donation.

9. The method according to claim 7, wherein the selected web pages includes information that influences an individual to make a donation.

10. The method according to claim 1, further comprising displaying information about other donors that have donated to the causes.

11. The method according to claim 10, further comprising displaying a virtual plaque honoring the donors.

12. The method according to claim 11, further comprising updating the virtual plaque to honor new donors.

13. A web-based, interactive system for determining a person's interest with respect to charitable, philanthropic or political causes and for soliciting donations, the method having a graphical user interface including a display, comprising:
means for asking a first question related to the causes;
means for receiving a response to the first question;
means for determining if subsequent questions are necessary to identify one or more causes;
means for asking one or more subsequent questions;
means for identifying at least one cause; and
means for asking for a donation.

14. The system according to claim 13, further comprising means for receiving a donation.

15. The system according to claim 13, wherein the interactive system is associated with an on-line event on the Internet.

16. The system according to claim 13, wherein the interactive system is implemented in a web-cast.

17. The system according to claim 13, wherein the questions influence an individual to make a donation.

18. The system according to claim 13, further comprising web pages having information about the causes.

19. The system according to claim 13, further comprising information about other donors that have donated to the causes.

20. The system according to claim 13, further comprising one or more virtual plaques honoring the donors.

21. The system according to claim 20, further comprising means for updating the virtual plaques to honor new donors.

22. A computer program product including a program code embodied in a storage medium for carrying out a web-based, interactive method for determining a person's interest with respect to charitable, philanthropic or political causes and for soliciting donations during an on-line web-cast on the Internet, the method having a graphical user interface including a display, comprising:
asking a first question related to the causes;
receiving a response to the first question;
determining, based on the response, if subsequent questions are necessary to identify one or more causes;
if subsequent questions are not necessary, identifying, based on the response, at least one cause;
asking one or more subsequent questions, if necessary, based on the prior response;
identifying, based on the responses, at least one cause; and asking for a donation.
